(19) United States
(12) Patent Application Publication
(10) Pub. No.: US 2014/0230746 A1
(43) Pub. Date: Aug. 21, 2014

(54) Animal Enclosure

(71) Applicant: Paul Chapman, Carina Heights, Queensland (AU)

(72) Inventor: Paul Chapman, Carina Heights (AU)

(21) Appl. No.: 14/350,100

(22) PCT Filed: Oct. 5, 2012
(86) PCT No.: PCT/AU2012/001211

§ 371 Date: Apr. 7, 2014

(30) Foreign Application Priority Data
Oct. 7, 2011 (AU) 2011904155

(51) Int. Cl. A01K 1/03; A01K 1/00

(52) U.S. Cl. CPC A01K 1/03; A01K 1/0035
USPC 119/453; 119/497

(57) ABSTRACT

The present invention concerns an animal enclosure (1). In particular, the present invention concerns an animal enclosure (1) including one or more enclosure units (2) adapted to contain an animal. Each enclosure unit (2) includes interconnection means (4) for connecting the enclosure unit (2) to one or more other enclosure units (2).

### TECHNICAL FIELD

The present invention concerns an animal enclosure and animal enclosure system.

### BACKGROUND

The reference to any prior art in this specification is not, and should not be taken as an acknowledgement or any form of suggestion that the prior art forms part of the common general knowledge.

An animal enclosure is typically used to confine one or more animals to a designated area. An animal enclosure, inter alia, may also be used to:
to shelter and protect the confined animal preventing the confined animal from wandering off where it may become lost, stolen, or endangered;
to protect a surrounding area or animals from the confined animal; and
for selective breeding purposes.

Domestic animals, in particular cats, are often confined in animal enclosures. Such animal enclosures allow the animal to exercise and play in a controlled outside or inside environment. In this respect it has been found that allowing animals, in particular cats, to exercise in an outside environment can often ameliorate many behavioural issues that arise from living inside a human dwelling in today's urban environment.

Typically, domestic animal enclosures for use in an outside or inside environment are usually in the form of a large bulky cage constructed of a metal or wooden frame with a steel wire mesh. Problems that arise from such enclosures are:
they are difficult to set up
they are difficult to move or adjust after being set up; and
they are permanent/semi-permanent structures.

Thus, there is a need for an alternative animal enclosure.

### SUMMARY OF THE INVENTION

It is an object of an embodiment of the present invention to provide an animal enclosure that minimizes a problem referred to above, or provides the public with a useful or commercial choice.

According to an aspect of the present invention, there is provided an animal enclosure including an enclosure unit adapted to contain an animal, said enclosure unit including interconnection means for connecting said enclosure unit to one or more other enclosure units.

According to another aspect of the present invention, there is provided an animal enclosure including an enclosure unit adapted to contain an animal, the enclosure unit including:
interconnection means for connecting the enclosure unit with one or more other enclosure units, said interconnection means adapted to directly connect with one or more other enclosure units;
a plurality of attachment portions for attaching enclosure accessories;
at least one access mechanism adapted to provide access to the internal space of the enclosure unit;
a movement mechanism for moving the enclosure unit over a surface; and
at least one handle portion for handling the enclosure unit.

According to yet another aspect of the present invention, there is provided an animal enclosure including an enclosure unit adapted to contain an animal, the enclosure unit including:
interconnection means for connecting the enclosure unit with one or more other enclosure units, said interconnection means adapted to connect with one or more other enclosure units via an enclosed passageway;
a plurality of attachment portions for attaching enclosure accessories;
at least one access mechanism adapted to provide access to the internal space of the enclosure unit;
a movement mechanism for moving the enclosure unit over a surface; and
at least one handle portion for handling the enclosure unit.

According to a further aspect of the present invention, there is provided an animal enclosure system including one or more enclosure units adapted to contain an animal and interconnection means for connecting said one or more enclosure units to one another.

According to yet a further aspect of the present invention, there is provided a modular animal enclosure including:
at least two enclosure units adapted to contain an animal; and
interconnecting means for connecting said at least two enclosure units to one another.

Preferably, all aspects of the present invention are for use in an inside environment, however, use should in no way be limited solely to an inside environment. It is envisaged that the above aspects of the present invention may be temporarily or semi-permanently employed in an outside environment or in a combination of both environments, e.g., an animal enclosure unit located in an inside environment connected via an enclosed passageway to a further animal enclosure unit located in an outside environment.

The animal enclosure, animal enclosure system and modular animal enclosure of the present invention may be used to contain cats, rabbits, guinea pigs, hamsters, weasels, ferrets, dogs, rats, mice or any other like animal. Preferably, the animal enclosure, animal enclosure system and modular animal enclosure of the present invention are adapted to contain cats.

In an embodiment of the present invention, an animal enclosure is provided that includes an enclosure unit adapted to contain an animal and be connected to one or more other enclosure units thereby providing a multi-configurable animal enclosure that is easy to set up and store away, readily rearranged by moving one or more of the enclosure units relative to the other enclosure units and readily expanded or contracted by adding or removing enclosure units. In essence, the animal enclosure according to an embodiment of the present invention has the potential to grow with the animal providing a safe environment for the animal. The modular design of the animal enclosure allows the enclosure to be fitted into irregular shaped spaces where conventional animal enclosures may not have been able to fit.

The enclosure unit may be of any size, shape and construction suitably adapted to contain an animal. The enclosure unit may be formed from any suitable material. Typically, the enclosure unit will be formed from a material that is able to be cleaned and that allows water and other liquid wastes to drain readily. Preferably the enclosure unit is formed from plastic or fabric, and more preferably a synthetic fabric. Most preferably, the enclosure unit may be formed from a nylon fabric.

The fabric may be water proofed. The fabric may be stain resistant. Preferably, the fabric may have a high abrasion resistance. It is envisaged that the enclosure unit may be formed from a nylon fabric of any desired colour and/or texture.

The enclosure unit may have at least one expandable portion, said expandable portion adapted to move between an expanded state and a contracted state. The expandable portion may be of any size, shape and construction.

The enclosure unit may have viewing means to allow a user to see an animal within the enclosure unit and likewise for a confined animal to see outside the enclosure unit. The viewing means may be one or more small windows in one or more walls of the enclosure unit. The viewing means may be a portion of mesh, a slit, a window, or any other suitable means allowing visibility in and out of the enclosure unit while not allowing the animal to escape via the viewing means. Typically, the viewing means is a slit or a portion mesh incorporated in one or more walls of the enclosure unit.

Preferably, the viewing means is one or more portions of mesh incorporated in one or more walls of the enclosure unit. An advantage of using mesh as the viewing means is that the mesh provides good ventilation and air flow within the enclosure unit. Good ventilation and air flow may keep the confined animal well and the enclosure unit from smelling.

Typically, the enclosure unit may have a cube shape, spheroid shape or polyhedral shape.

In one embodiment the enclosure unit has a cube shape. The cube shaped enclosure unit may be formed from any suitable means. The cube shaped enclosure unit may be of unitary construction, i.e, injection moulded.

The cube shaped enclosure unit may be formed from panels connected to one another by fastening means. Preferably, the cube shaped enclosure unit is formed from panels connected to one another by fastening means. Any suitable fastening means may be used to connect the panels to one another. The fastening means may include adhesive bonding, any form of joinery, stitching, or any other suitable means for joining one panel to another. Preferably, the fastening means includes joinery and more preferably includes a dovetail mortise and tenon joint.

In a preferred embodiment, the panels of the cube shaped enclosure unit are connected to one another by dovetail mortise and tenon joints. The tenon may be a through tenon and have a substantially dovetail shaped profile. The through tenon, typically, extends from the peripheral edge of a panel. The through tenon may engage with and extend through a corresponding mortise disposed at or near an adjacent panel edge. The cube-shaped enclosure unit may have a panel floor. Alternatively, the cube-shaped enclosure unit may not have a panel floor, using instead the floor upon which the enclosure unit is placed.

The protruding portion of the through tenon once it has engaged with and extended through a corresponding mortise may then be secured by any suitable means. Typically, the through tenon includes an aperture defined at or near the protruding end of the through tenon and, once the tenon has engaged with a corresponding mortise, may be secured by passing a wedge, clip or any other suitable means through the aperture. Preferably, the dovetail mortise and tenon joint is secured by a clip. More preferably, the clip has a substantially z-shaped profile adapted to prevent the clip from inadvertently disengaging from the looped dovetail projection.

The enclosure unit may be demountable and/or collapsible for ease in storage of the enclosure unit when not in use. The enclosure unit may be collapsed or demounted by any suitable means. The enclosure unit may include locking means to prevent the inadvertent collapsing or demounting of the enclosure unit and also to lock the unit in the collapsed or demounted state.

In another preferred embodiment, the cube shaped enclosure unit may be formed from fabric supported by an internal cube-shaped frame. The fabric may be attached to the internal frame by any suitable fastening means. Typically, the fabric is attached to the frame by releasable fastening means adapted to allow the fabric to be at least partially disassembled from the frame for cleaning or adjustment. Preferably, the fabric is attached to the frame by one or more loops of fabric with hook and loop or snap fasteners for looping and fastening the one or more loops of fabric around the internal frame.

The frame may be of any size, shape and construction and formed from any material or materials suitably adapted to form a frame for a cube shaped enclosure unit. The frame may be formed from a plurality of frame members. The frame may be adapted to be readily set up and disassembled. Preferably, the frame may be at least partially collapsed and expanded between one or more collapsed and expanded states, respectively. The frame may be formed from any suitable lightweight, strong and corrosion resistant material. All moving parts of the frame may, preferably, be concealed with rounded edges to reduce the risk of injury to the user and the confined animal. The frame may have a locking mechanism to lock the frame in at least a partially set up state or collapsed state. The frame may further include one or more stabilizers for stabilizing the frame in the expanded state relative to the environment in which it has been set up.

Preferably, the frame is adapted to be collapsed and expanded whilst attached to the fabric. Preferably, the frame may be at least partially expanded and collapsed into at least two expanded and collapsed states, respectively. A fastening mechanism may be provided on the fabric exterior to secure the enclosure unit in the collapsed state.

The enclosure unit may have an internal floor. The internal floor may be removable. The internal floor may be rigid. The internal floor may be of any suitable size, shape or construction and may be formed from any suitable material or materials. Typically, the internal floor is substantially rigid and formed of plastic, such as polypropylene, adapted to be readily cleaned. Preferably, the internal floor is a rigid insert adapted to be inserted and removed by an external access mechanisms located on one or more walls of the enclosure unit.

The enclosure unit may include one or more dividing walls or panels adapted for dividing the internal space of the enclosure unit. The dividing walls or panels may be removable. The walls or panels may define one or more apertures adapted to allow the confined animal to traverse between the divided internal space. The one or more apertures may include a flap or door that is able to more between an open or closed position and able to be locked in either the open or closed positions. The flap or door may be adapted to be moveable between the open or closed positions by the animal.

Preferably, the one or more dividing walls or panels may be rigid inserts adapted to be inserted into a corresponding and receiving portion of the enclosure unit. More preferably, the rigid inserts may be at least partially inserted into the enclosure unit and removed from the enclosure unit from one or more external access mechanisms located on one or more walls of the enclosure unit.

The enclosure unit may further include an access mechanism for accessing the internal space of the enclosure unit. The access mechanism may be of any size, shape and construction suitably adapted to allow a user access to the internal space of the enclosure unit, e.g., for cleaning the enclosure unit, inserting or removing an internal floor or one or more dividing walls, introducing or removing enclosure features, or for retrieving the animal from the enclosure unit. Preferably, the access mechanism is a door, flap or hatch able to move between an open and a closed position and able to be locked or secured in the open or closed position. The door, flap or hatch may be rigid. The door, flap or hatch may be locked or secured in the open or closed positions by any suitable means. Preferably, the door, flap or hatch is locked or secured by a zip fastener, snap fastener, hook and loop fastener or any other like fastener.

The door, flap or hatch may further include an animal access flap suitably adapted to allow the animal to enter and exit the enclosure unit when the animal access flap is in the open position. Preferably, the animal is able to move the animal access flap between open and closed positions. Preferably, the animal access flap may be locked or secured in either the open or closed position. Typically, the animal access flap may be locked or secured in either the open or closed position by any suitable fasteners mentioned above and used to lock or secure the door, flap or hatch.

In another embodiment the enclosure unit is spheroidally shaped. The spheroidal shape may be formed by any means and may be of any construction suitably adapted to contain an animal. The spheroidally shaped enclosure unit may be formed by moulding.

Typically, the spheroidally shaped enclosure unit may be formed from more than one part. Preferably, the spheroidally shaped enclosure unit may be formed from a substantially hemispherical base with a corresponding hatch or cover adapted to move between an open and closed position. In the open position, the internal space of the enclosure unit may be accessible.

The hatch may be connected to the hemispherical base by any suitable means. The hatch may be hinged and swing between an open and closed position. The hatch may be connected to the hemispherical base such that it slides between the open and closed position. The hatch may be lockable in the open or closed positions.

The spheroidally shaped enclosure unit may include a stand. The stand may be of any size, shape or construction suitably adapted to support the spheroidally shaped enclosure unit. The stand may be fastened to the spheroidally shaped enclosure unit. The stand may be releasably fastened to the spheroidally shaped enclosure unit.

Preferably, the enclosure unit includes a plurality of attachment portions for attaching for enclosure accessories. The enclosure accessories may include animal entertainment features and/or gripping means. The attachment portions may be located on the outside and/or inside of the enclosure unit. The attachment portions may be of any size, shape and construction. The attachment portions may be suitably sized apertures adapted to receive the various device, e.g., a scratch pole, ramp, or food/water bowl. Alternatively, the attachment portions may be a projection sized and shaped to engage with a corresponding groove or depression on the various device. The attachment portions may provide permanent or releasable attachment of the various device.

Preferably, the enclosure unit includes movement mechanism. The movement mechanism may be of any size, shape or form suitably adapted to allow a user to move the enclosure unit to a desired location. The movement mechanism may be rollers, a sliding mat or wheels disposed on an external surface of the enclosure unit. Preferably, the movement mechanism are wheels disposed on the bottom external surface of the enclosure unit.

The enclosure unit may include a handle portion for assisting a user in handling the enclosure unit. The handle portion may be of any size, shape or form and may be positioned on the enclosure unit in any position suitably adapted to allow a user to handle the enclosure unit. The handle portion may include a strap, a handle, a loop, a projection or any like means suitably adapted to be gripped and handled by a user.

The enclosure unit may include gripping means adapted to allow an animal to grip the external surface when traversing the external surface of the enclosure unit. The gripping means may be of any suitable form, texture and construction. Preferably, the external gripping means includes carpet and/or slits in the panels. The slits preferably being sized and shape to allow an animal to gain a perch upon the slit.

The enclosure unit may include an internal resting portion adapted to provide a comfortable place for the animal to rest. The resting portion may be of any suitable size, shape or form. The resting portion may be a cushion or padded portion of the enclosure unit. The resting portion may be a receptacle defined by the enclosure unit and adapted to contain cushioning material or substance. Preferably, the resting portion is a portion of moulded foam. The resting portion may be permanently or releasably attached to the enclosure unit.

The interconnection means may of any form suitably adapted to connect an enclosure unit with one or more other enclosure units. The enclosure units may be connected directly or indirectly.

If connected directly, the interconnection means preferably includes one or more apertures defined in one or more sides of the enclosure unit. The apertures may be adapted to at least partially align with one or more corresponding apertures in the one or more other enclosure units when placed adjacent to the at least one enclosure unit. When the apertures are aligned and the enclosure unit and the one or more other enclosure units are interconnected, passage may be provided for the contained animal to traverse between the connected enclosure units.

The adjacent enclosure units may include fastening means for releasably fastening the units to one another. Such fastening means may be of any form suitably adapted to attach and detach. Preferably, the fastening means may be draw string fasteners, hook and loop fasteners, snap fasteners, or zip fasteners.

If connected indirectly, the interconnection means preferably includes one or more apertures defined in one or more sides of the enclosure unit. Each said aperture may be adapted to at least partially engage with an enclosed passageway. The enclosed passageway may be adapted to provide a passage for the contained animal between the enclosure unit and a further enclosure unit.

The enclosure unit and the at least partially engaged enclosed passageway may include fastening means for releasably fastening the unit and the passageway to one another. Such fastening means may be of any form suitably adapted to attach and detach Preferably, the fastening means may be draw string fasteners, hook and loop fasteners, snap fasteners, or zip fasteners.

The enclosed passageway used to connect enclosure units may be of any size, shape and form suitably adapted to engage with the one or more apertures. The enclosed passageway may be or include a tunnel or a ramp. Preferably, the enclosed passageway is a collapsible tunnel that is collapsible when not being used for ease in storage but is substantially non-collapsible when extended between two animal enclosure units.

The enclosed passageway may be a fabric tunnel. The fabric tunnel may include an internal substantially helical support frame. The internal substantially helical support frame being adapted to allow the fabric tunnel to at least partially collapse along the longitudinal axis but not the transverse axis of the tunnel. The tunnel may have one or more viewing means incorporated in the wall of the tunnel. Preferably, the viewing means are one or more portions of mesh incorporated in the wall of the tunnel. The fabric tunnel may have a substantially circular or D-shaped profile. Preferably, the fabric tunnel may have a D-shaped profile thereby providing the animal with a flat floor to walk on.

Alternatively, the fabric tunnel may have a rectangular or square-shaped profile. Such a fabric tunnel may therefore have a hooped internal support frame adapted to allow the tunnel to collapse along the tunnel's longitudinal axis and not the transverse axis of the tunnel.

The enclosed passageway may include a ramp. The ramp may be of any suitable size, shape and construction. The ramp may be formed from one or more ramp portions, each ramp portion adapted to angled to any suitable angle with respect to the other ramp portions. Preferably, the ramp may include at least two ramp portions.

Any of the features described herein can be combined in any combination with any one or more of the other features described herein within the scope of the invention.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary Of The Invention in an way. The detailed description will make reference to a number of drawings as follows:

FIG. 1 is a forward perspective view of an enclosure unit in accordance with an embodiment of the present invention;

FIG. 2 is a forward perspective view of the enclosure unit of FIG. 1 with the door open;

FIG. 3 is a forward perspective view of the enclosure unit of FIG. 1 connected to a further enclosure unit;

FIG. 4 is a side view of FIG. 3;

FIG. 5 is a bottom perspective view of the enclosure unit of FIG. 1 showing the wheels; and

FIG. 6 is a plan view of a panel from a further enclosure unit adapted to connect with the bottom of the enclosure unit of FIG. 1;

FIG. 7 is a perspective view of the dovetail-shaped tenon used to fasten the panel of FIG. 6 to other panels;

FIG. 8 is a perspective view of the dovetail-shaped tenon of FIG. 7 further secured by a clip with a substantially Z shaped profile;

FIG. 9 is a perspective view of the substantially Z shaped clip shown in FIG. 8;

FIG. 10 is a top perspective view of an enclosure unit in accordance with another embodiment of the present invention connected via an enclosed passageway;

FIG. 11 is a top perspective view of the enclosure unit shown in FIG. 12 in a collapsed state;

FIG. 12 is a top perspective view of the enclosed passageway shown in FIG. 12;

FIG. 13 is a perspective view of the enclosure unit of FIG. 12 connected via an enclosed passageway to a further enclosure unit;

FIG. 14 is a perspective view of the enclosure unit of FIG. 10 with the rigid floor insert partially removed;

FIG. 15 is a perspective view of the enclosure unit of FIG. 10 in an expanded state;

FIG. 16 is a perspective view of the frame only from FIG. 15;

FIG. 17 is a perspective view of the frame of FIG. 16 in an alternative set up;

FIG. 18 is a sectional perspective view of an enclosed passageway;

FIGS. 19a to 19f are perspective views of a ramp in varying set ups;

FIGS. 20a to 20e are perspective views of an animal enclosure in accordance with an embodiment of the present invention exemplifying the multi-configurability of the animal enclosure;

FIGS. 21a to 21c are perspective views of an enclosure unit of FIG. 20 in various configurations; and

FIGS. 22a to 22c are perspective views of the enclosure units of FIG. 20 interconnected in various configurations without an enclosed passageway;

FIG. 23 is a perspective view of a resting portion; and

FIG. 24 is a forward perspective view of an enclosure unit on a stand in accordance with another embodiment of the present invention.

### DETAILED DESCRIPTION OF PREFERRED EMBODIMENT(S)

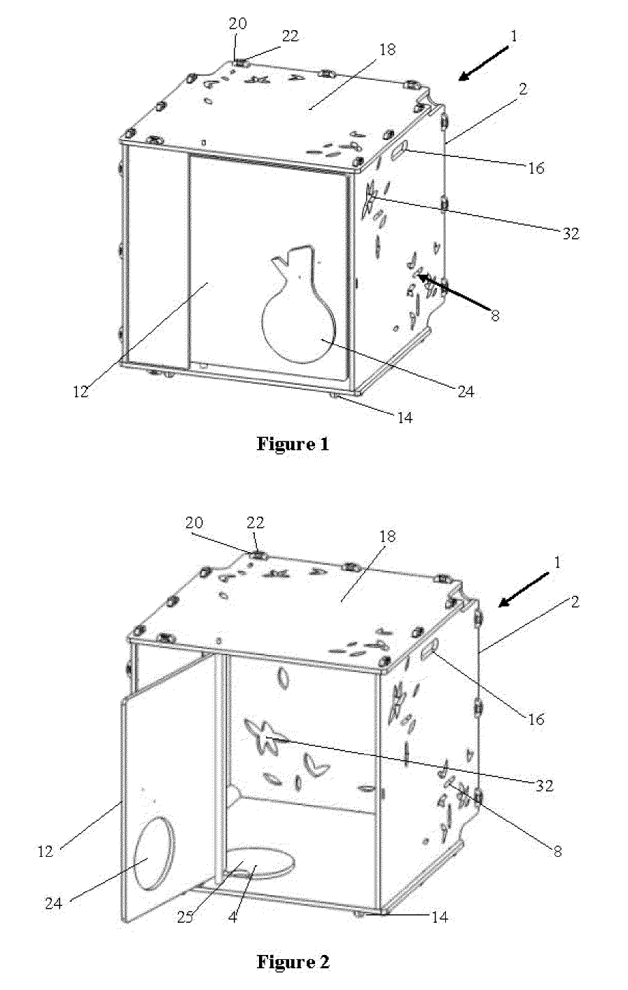

According to a first embodiment of the present invention, there is provided an animal enclosure 1 as shown in FIGS. 1 to 5 and 10 to 13. The animal enclosure 1 includes a unit 2 (i.e., enclosure unit) adapted to contain a cat (i.e., animal). The unit 2 includes connecting points 4 (i.e., interconnection means; shown in FIGS. 2, 5, 10, 12 and 13) for connecting the unit 2 with further units 2.

According to a second embodiment of the present invention, there is provided an animal enclosure 1 according to the above embodiment, wherein the connecting points 4 are adapted to directly connect with further units 2. The unit 2 includes attachment points 8 (i.e., attachment portions) to provide attachment points for attaching enclosure accessories including cat entertainment features 11 (i.e., animal entertainment features) or climbing apparatus 10 (i.e., gripping means). The unit 2 also includes a door 12 (i.e. access mechanism) for accessing the internal space of the unit 2 and wheels 14 (i.e., movement mechanism) for moving the unit to a desired location. Handles 16 (i.e., at least one handle portion) are provided for handling the unit 2.

According to a third embodiment of the present invention, there is provided an animal enclosure 1 according to the above embodiment, wherein the connecting points 4 are adapted to connect with further units 2 via a tunnel 6 (i.e., enclosed passageway). The unit 2 includes attachment points 8 (i.e., attachment portions) to provide attachment points for attaching enclosure accessories including cat entertainment features (i.e., animal entertainment features) or climbing apparatus 10 (i.e., gripping means). The unit 2 also includes a door 12 (i.e. access mechanism) for accessing the internal space of the unit 2 and wheels 14 (i.e., movement mechanism) for moving the unit to a desired location. Handles 16 (i.e., at least one handle portion) are provided for handling the unit 2.

According to a fourth embodiment of the present invention, there is provided an animal enclosure system including one or more units 2 according to the first embodiment. Each unit 2 having connecting points 4 for connecting units 2 together.

According to a fifth embodiment of the present invention, there is provided a modular animal enclosure 1. The modular animal enclosure including at least two units 2 according to the first embodiment. Each unit 2 have connections points 4 for connecting with the other unit 2.

Referring to FIGS. 1 and 2, the unit 2 is cube shaped and formed from six panels 18 connected to one another via dovetail mortise and tenon joints. The tenon 20 has a substantially dovetail-shaped profile and has a hole 28 at or near an end portion of the tenon 20. The tenons 20 extend from the peripheral edge of a panel 18. The tenons 20 engage with and extend through corresponding mortises located at or near the peripheral edge of adjacent panels 18. The connected panels 18 are then further secured by z-clips 22 (i.e., clips with a substantially z-shaped profile), which pass through the hole at or near an end portion of the tenon 20, once the tenon 20 has engaged with and extended through a corresponding mortise. The unit 2 has a door 12 for accessing the internal space of the unit 2. The door 12 can be closed (FIG. 1) and opened (FIG. 2) and is lockable. The door 12 further includes a cat flap 24 (i.e., animal access flap), which is also lockable in either a closed or opened position. The panels 18 of the unit 2 include numerous attachment points 8.

Referring to FIG. 2, the bottom panel 18 includes a connection point 4 for connecting with other units 2. The connection point 4 is an opening 25 shown in a closed state. The unit 2 includes handles 16 and wheels 14 for ease in moving the unit 2.

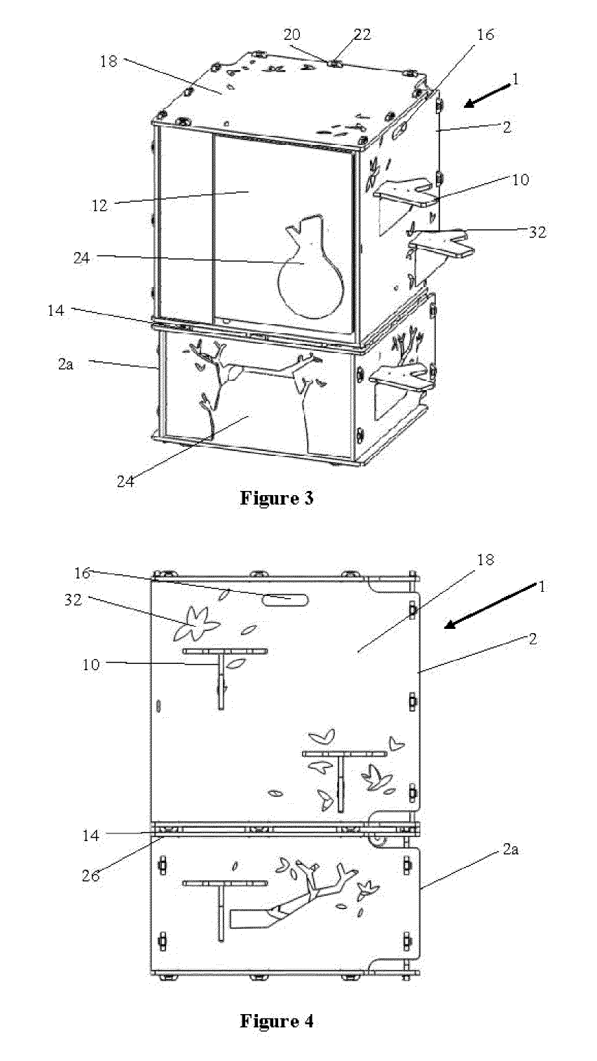

FIGS. 3 and 4 show the unit 2 shown in FIGS. 1 and 2 directly connected to another unit 2a. The unit 2 sits directly on top of the further unit 2a with the opening 25 (shown in FIG. 2) aligning with a corresponding opening in the top surface of the further unit 2a. The opening 25 (shown in FIG. 2) is moved to an open state allowing a cat to move between the units 2, 2a. Additionally, the wheels 14 of the unit 2 are received in corresponding holes 26 in the top surface of the further unit 2a to secure the connected units 2, 2a. Climbing apparatus 10 have been fitted to some of the attachment points 8 to allow a cat to climb the external surface of the animal enclosure 1.

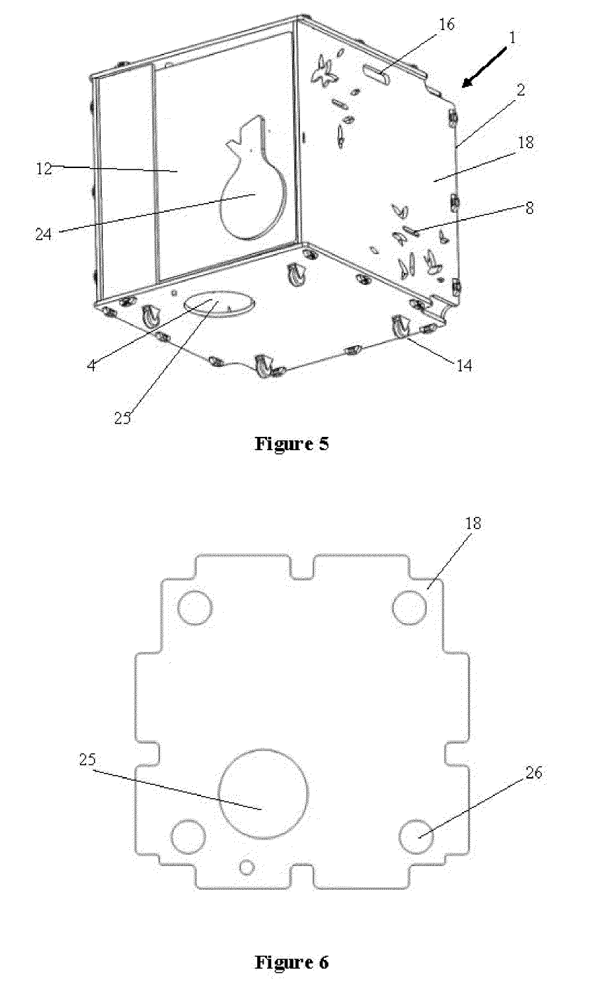

Referring to FIG. 5, the bottom panel 18 of the unit 2 shown in FIGS. 1 and 2 is shown. The wheels 14 are clearly visible as is the opening 25 adapted to allow a cat to move between units 2 when connected.

FIG. 6 shows the top corresponding panel of the further unit 2a shown in FIGS. 3 and 4. The wheels from unit 2 are received and retained in the corresponding holes 26. The opening 25 aligns with the corresponding opening 25 from unit 2 when the units 2, 2a are connected.

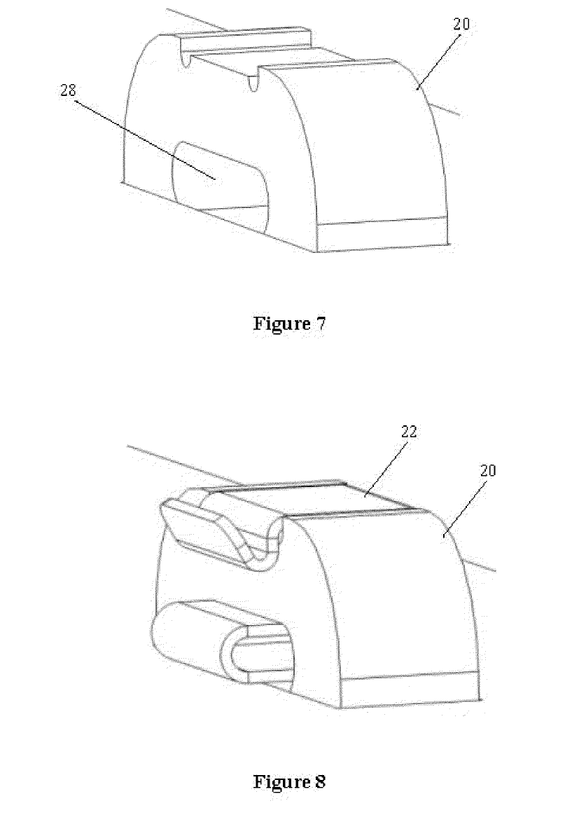

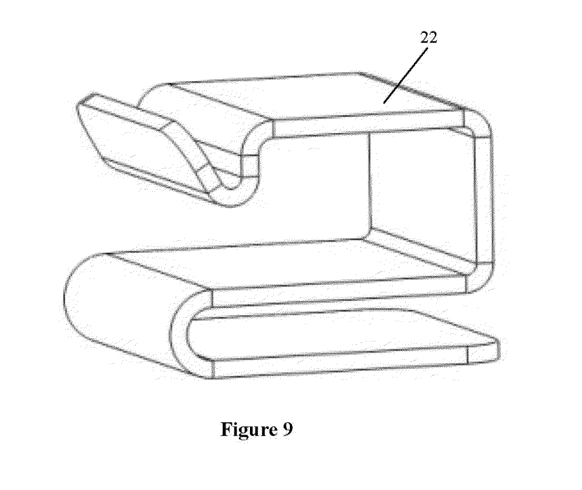

FIGS. 7, 8 and 9 show the substantially dovetail-shaped tenon 20 and z-clip 22 (FIGS. 8 and 9 only) used to connect the panels (not shown) of the unit to one another. FIG. 7 shows the hole 28 defined by the substantially dovetail-shaped tenon 20. FIG. 8 shows how the z-clip 22 is at least partially received in the hole 28 to secure the protruding substantially dovetail-shaped tenon 20 in place thereby preventing the connected panels 18 from disengaging. FIG. 9 shows the z-clip in detail.

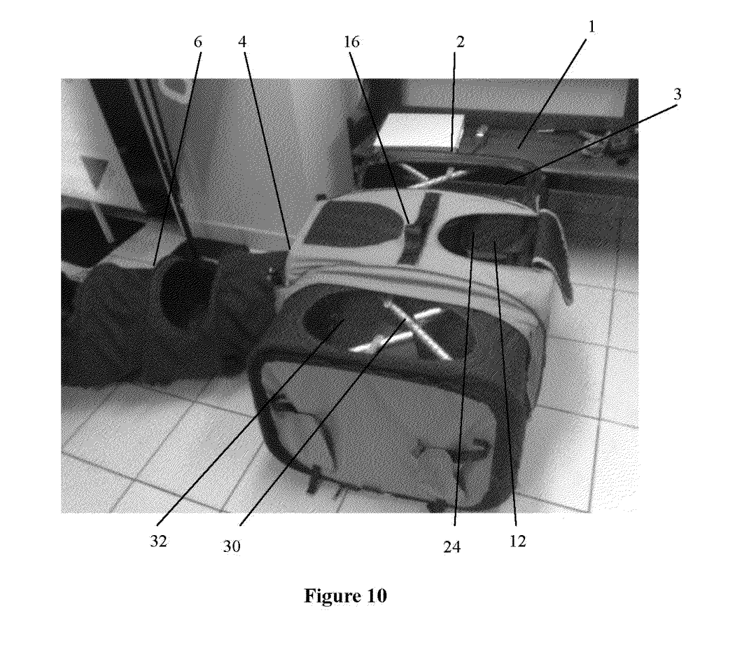

FIGS. 10 to 17 show another embodiment of the enclosure unit 2 of the present invention.

Referring to FIG. 10, the enclosure unit 2 is formed from fabric stretched over an internal supporting structure 30 (i.e., frame). Both expandable portions 3, located on either side of the enclosure unit 2 are shown in the expanded state. The enclosure unit 2 has mesh windows 32 (i.e., viewing means) and two doors 12 (one shown in closed and the other open) for accessing the internal space of the unit 2. A handle 16 is positioned on top of the unit 2 for handling the unit 2. The unit 2 has a connection point 4 for connecting to another unit via a tunnel 6.

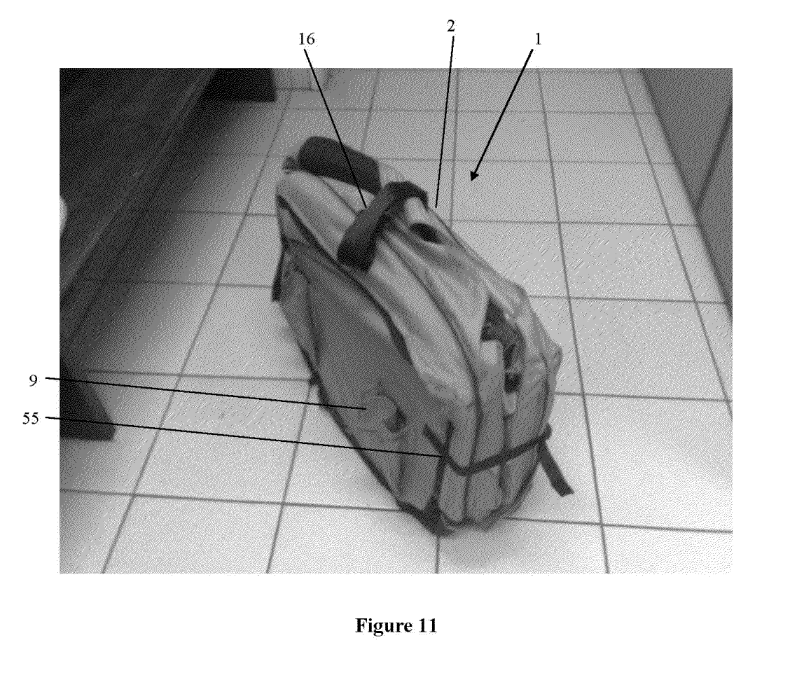

FIG. 11 shows the enclosure unit 2 of FIG. 10 in a collapsed state. A strap 55 secures the enclosure unit 2 in the collapsed state.

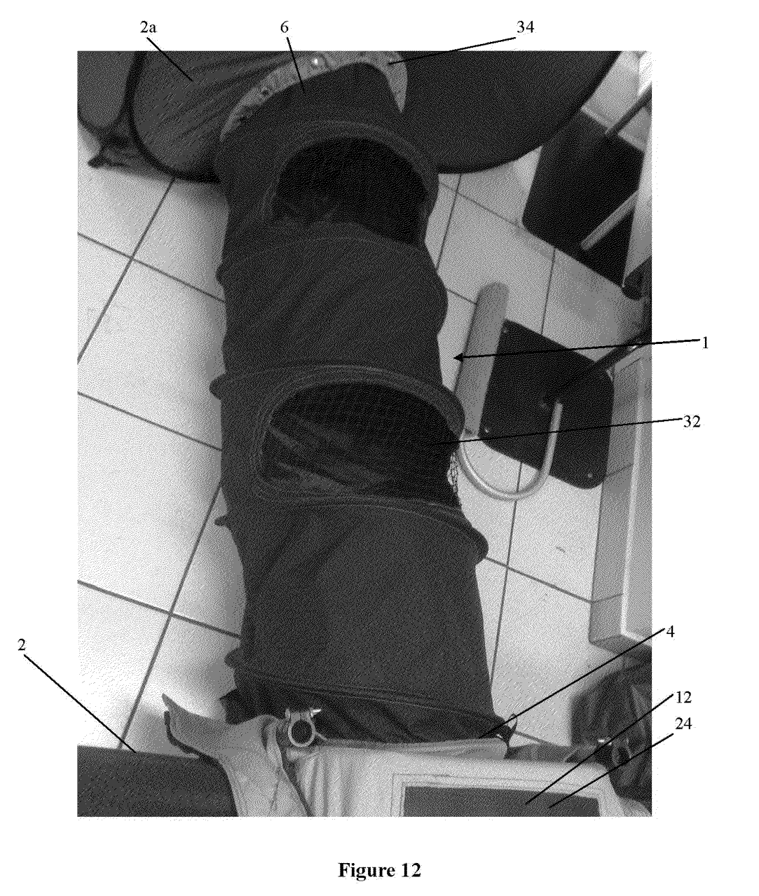

FIG. 12 shows a tunnel 6 connecting the enclosure unit 2 of FIG. 10 with a further unit 2a. The tunnel 6 has mesh windows 32 and is connected to the connection point 4 of each unit 2, 2a via snap fasteners 34.

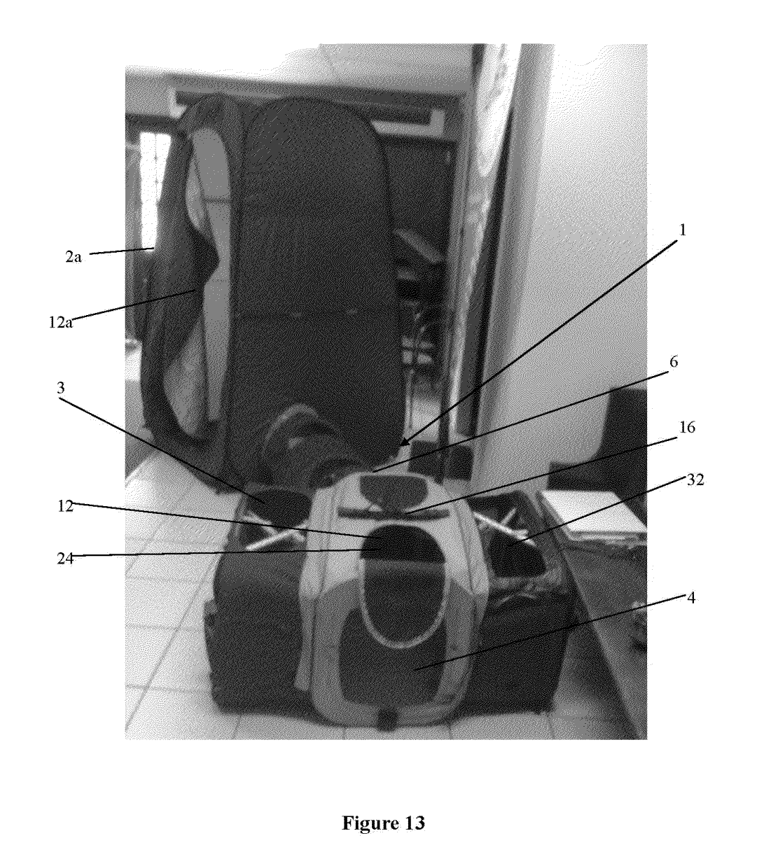

FIG. 13 shows the unit 2 of FIG. 10 connected via the tunnel 6 of FIG. 12 to a further unit 2a. The further unit 2a has large door 12a for accessing the internal space of the further unit 2a. FIG. 13 also shows the non-used connection point 4 of unit 2 in a closed state.

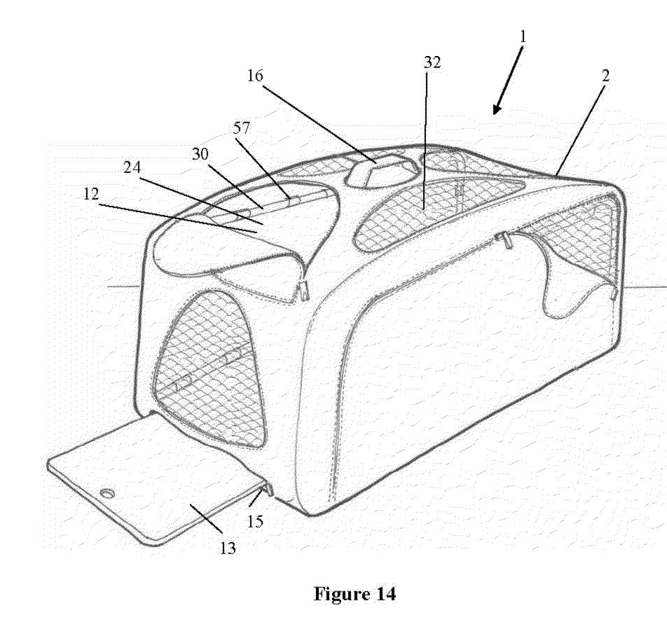

FIG. 14 shows the unit 2 of FIG. 10 by itself with the floor insert 13 (i.e., internal floor) in a semi-inserted/removed state. The floor insert 13 is inserted and removed via the zipped access point 15. Fabric loops 57 secure the fabric exterior to the internal supporting structure 30.

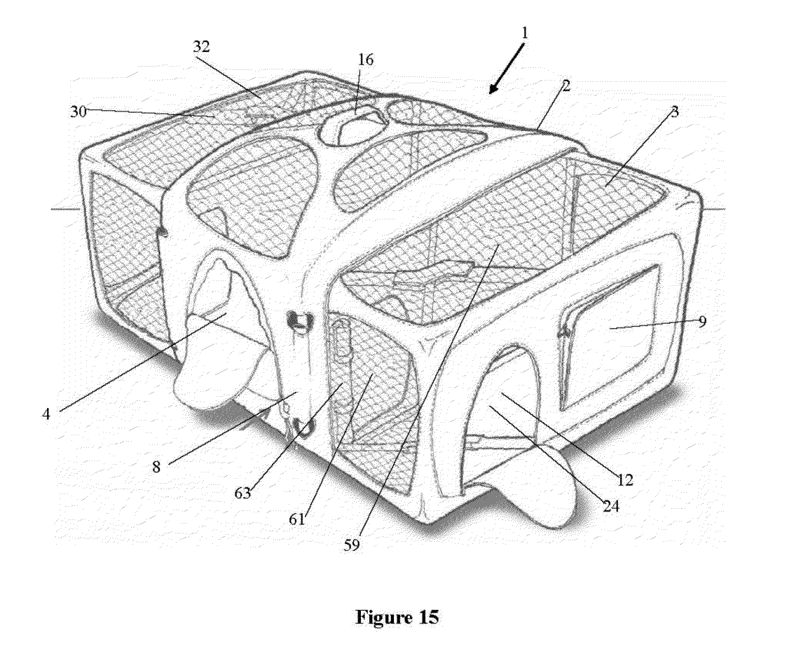

FIG. 15 shows the unit 2 of FIG. 10 by itself with both expandable portions 3 in an expanded state. Attachment points 8 are visible on the external surfaces of the unit 2. A pocket 9 is also provided on the side of the unit 2 for containing miscellaneous items. A dividing wall 59 divides the internal space of the enclosure unit 2. A hole 61 (i.e., aperture) with a closable flap 63 in the dividing wall allows a confined cat to move between the divided sections of the enclosure unit. The flap 63 is shown in the open position rolled up beside the hole 61

FIG. 16 shows the internal supporting structure 30 of the unit 2 of FIG. 10 without the external fabric when the expandable portions 3 are in the expanded state.

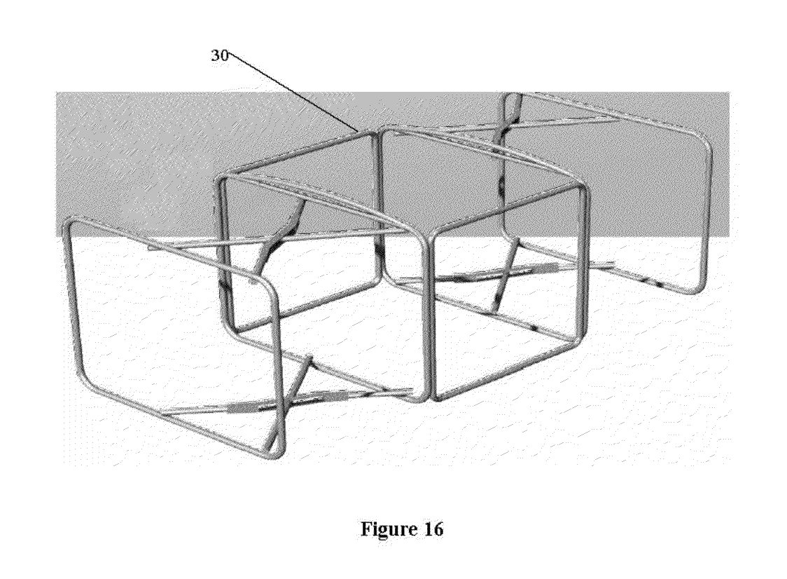

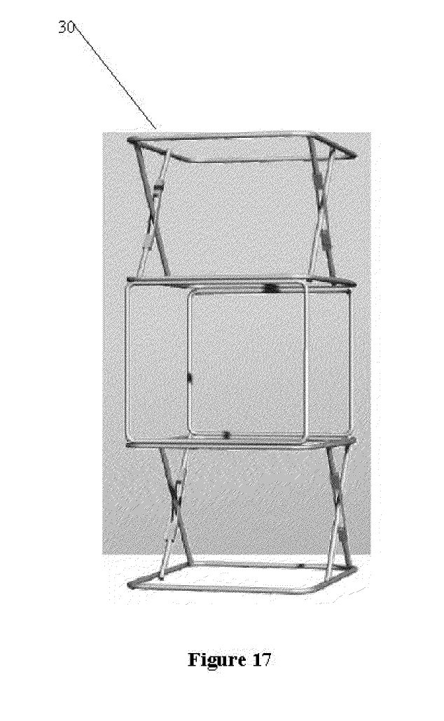

FIG. 17 shows a variation of FIG. 16 in which the unit 2 of FIG. 10 may also be placed on its end as the internal supporting structure is adapted to be also stable in this set up.

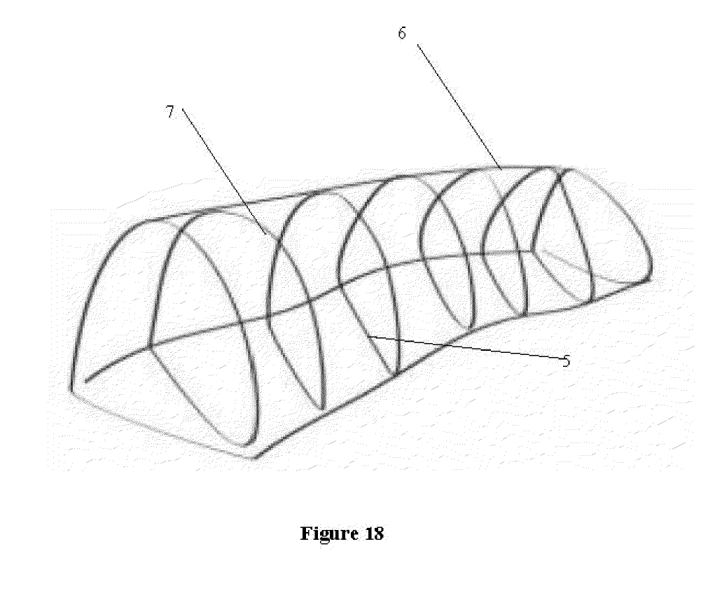

Referring to FIG. 18, the tunnel 6 has a d-frame 7 (i.e., hooped internal support frame) adapted to allow the tunnel 6 to collapse along the tunnel's longitudinal axis but not the transverse axis of the tunnel. The d-frame 7 provides a flat portion 5, which rests upon the ground stabilizing the tunnel 6 preventing it from rolling and providing the cat with a flat floor to walk on.

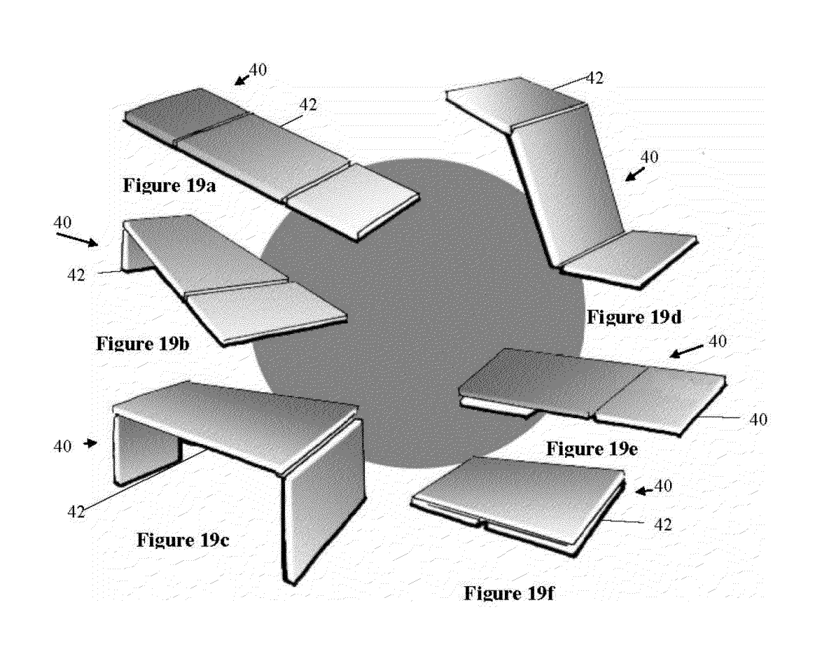

FIGS. 19a to 19f show a ramp 40, which may be used instead of a tunnel 6 or along with a tunnel 6 to connect one or more enclosure units 2. The ramp 40 includes three ramp portions 42, each ramp portion 42 is able to be folded, as exemplified in FIGS. 19a to 19f, to various angles with respect to the other ramp portions 42.

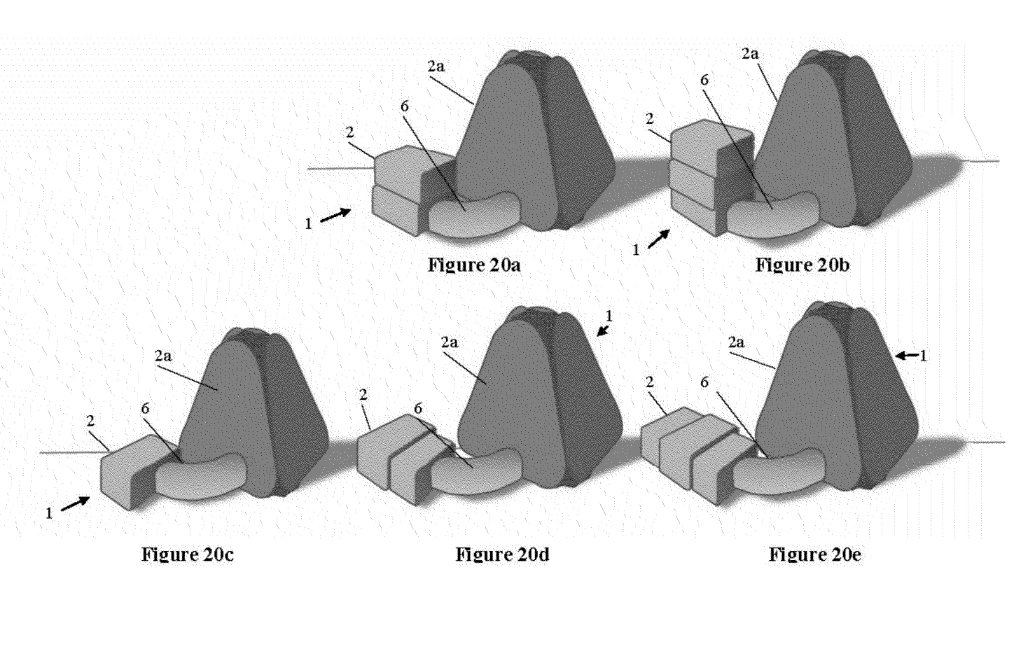

FIGS. 20a to 20e show an enclosure unit 2 of FIG. 10 connected to a further enclosure unit 2a by a tunnel 6 in various arrangements. As shown in FIGS. 20a and 20b and in FIG. 17, the enclosure unit 2, may also be set up on its side. FIGS. 20c to 20e show the enclosure unit in different expanded states in which none (FIG. 20c), one expandable portion 3 (FIG. 20d) and both expandable portions 3 (FIG. 20e) are in expanded states.

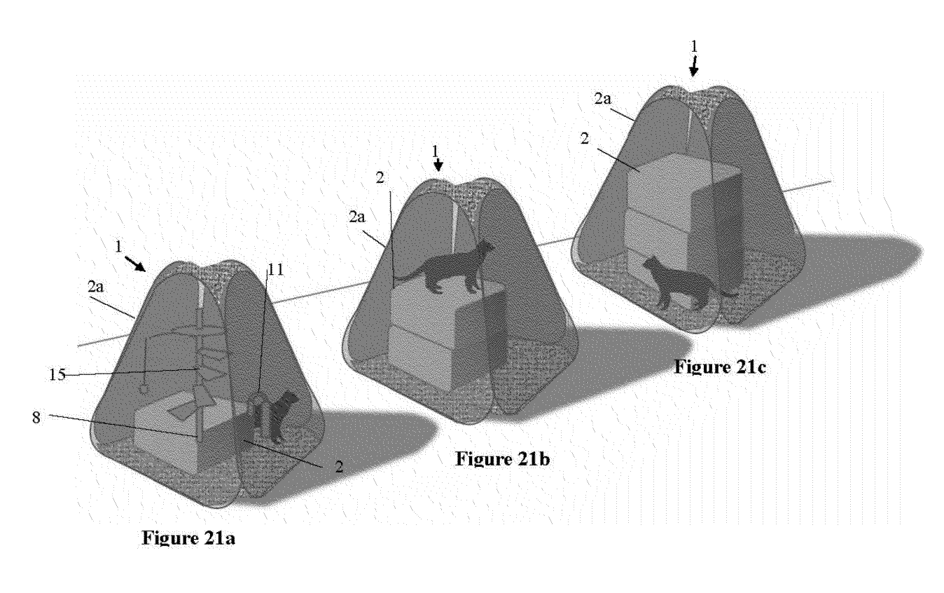

FIGS. 21a to 21c show an alternative arrangement, in which the enclosure unit 2 is placed within the further enclosure unit 2a. Various cat entertainment features 11 or climbing apparatus 15 may be attached to the external surface of the enclosure unit 2 via attachment points 8. As with FIGS. 20c to 20e, the enclosure unit 2 is shown on its side in various expanded states.

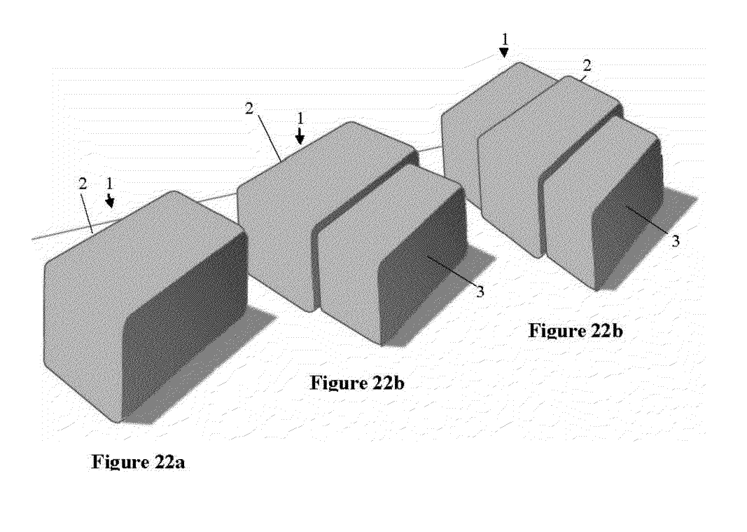

FIGS. 22a to 22b show the enclosure unit 2 of FIG. 10 in various expanded states. In 22a, both expandable portions 3 are in a contracted state. In FIG. 22b, one expandable portion 3 is in an expanded state. In FIG. 22c, both expandable portions 3 are in an expanded state.

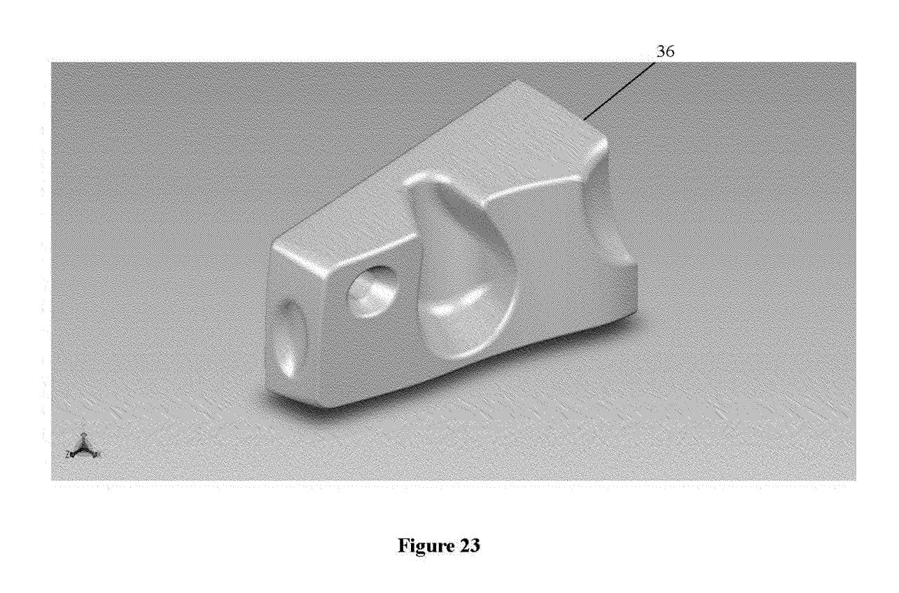

Moulded foam 36 (i.e., resting portion) is shown in FIG. 23. The moulded foam 36 is positioned in the internal space of the unit (not shown) to provide a comfortable resting position for a cat.

In use, any number of enclosure units 2 of FIGS. 1 to 9 or FIGS. 10 to 13 are assembled and arranged relative to one another in the desired location of an indoor or outdoor environment. The number of enclosure units 2 required is largely dependent on the activity of the cat or the number of cats intended to be contained within the animal enclosure 1.

The units 2 once assembled are either directly connected to one another as shown in FIGS. 3 and 4 or indirectly connected via a tunnel 6 as shown in FIGS. 11 to 13. Once connected the cats are able to traverse between the connected units 2. As shown in FIG. 21a, climbing apparatus 15 or other entertaining features may be added to one or more of the connected units 2.

Furthermore, the units 2 may be closed thereby confining the cat to the animal enclosure 1 (shown in FIGS. 21a to 21c) or the cat flap 24 or door 12 may be left open to allow cats to enter and leave the animal enclosure 1 as they please as shown in FIGS. 15 and 13, respectively.

The animal enclosure 1 may be rearranged at any time by moving units 2 relative to one another or by adding or removing units 2. The animal enclosure 1 may also be set up or packed up readily when desired which is beneficial when indoor space is limited or for cleaning purposes.

A person skilled in the art will appreciate that many embodiments and variations can be made without departing from the ambit of the present invention.

In another embodiment of the present invention, it is envisaged that the unit 2 alone shown in FIGS. 1 to 9 and FIGS. 10 to 13, not connected to any further units 2a, may be used to transit or contain cats. The unit 2 may be used to house cats in a home, boarding catteries or vet surgeries.

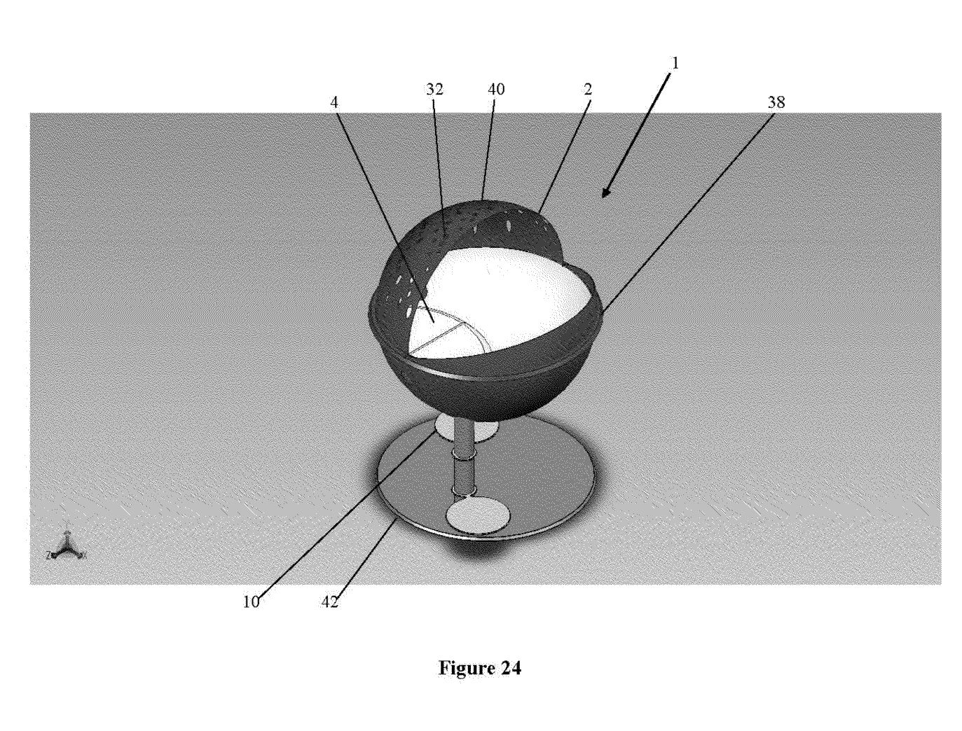

In another embodiment of the present invention, the enclosure unit 2 is spheroidally shaped as shown in FIG. 24. The spheroidally-shaped unit 2 having a base 38, a connection point 4 in the closed position and a hatch 40 connected to the base and able to move between a closed position and an open position. The hatch 40 includes numerous apertures 32 (i.e., viewing means) for viewing a cat within the unit 2. The unit 2 is mounted on a stand 42. The stand 42 has climbing apparatus 10 along the length of the stand 42 to allow a cat to climb to and from the unit 2.

Reference throughout this specification to “one embodiment” or “an embodiment” means that a particular feature, structure, or characteristic described in connection with the embodiment is included in at least one embodiment of the present invention. Thus, the appearance of the phrases “in one embodiment” or “in an embodiment” in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural of methodical features. It is to be understood that the invention is not limited to specific features shown or described since the means herein described comprises preferred forms of putting the invention into effect.

Throughout the specification and claims, unless the context requires otherwise, the term “comprise”, or variations such as “comprises” or “comprising”, will be understood to apply the inclusion of the stated integer or groups of integers but not the exclusion of any other integer or group of integers.

1-44. (canceled)

45. An animal enclosure including an enclosure unit for containing an animal, the enclosure unit including:
interconnection means for connecting the enclosure unit with one or more other enclosure units;
a plurality of attachment portions for attaching enclosure accessories including animal entertainment features or gripping means;
at least one access mechanism to provide access to the internal space of the enclosure unit;
a movement mechanism for moving the enclosure unit over a surface; and
at least one handle portion for handling the enclosure unit.

46. The animal enclosure of claim 45, wherein the interconnection means are adapted to connect one or more enclosure units directly with one another, said interconnection means including one or more apertures defined in one or more sides of each enclosure unit, said apertures adapted to at least partially align with one or more corresponding apertures in the one or more other enclosure units when placed adjacently.

47. The animal enclosure of claim 45, wherein the interconnection means are adapted to connect to an at least partially enclosed passageway to indirectly connect one or more enclosure units with one another, said interconnection means including one or more apertures defined in one or more sides of each enclosure unit, said apertures adapted to at least partially engage with the at least partially enclosed passageway and said at least partially enclosed passageway adapted to provide passage for an animal between the enclosure units.

48. The animal enclosure of claim 47, wherein the at least partially enclosed passageway is selected from the group consisting of one or more apertures, a tunnel, a ramp or any combination thereof.

49. The animal enclosure of claim 48, wherein the tunnel has a profile shape selected from the group consisting of substantially circular, substantially D-shaped, substantially rectangular and substantially square.

50. The animal enclosure of claim 45, wherein the enclosure unit includes an expandable portion moveable between an expanded state and a contracted state.

51. The animal enclosure of claim 45, wherein the enclosure unit further includes viewing means to allow an animal confined in the enclosure unit to be visualised, said viewing means selected from the group consisting of a portion of mesh, a slit and a window.

52. The animal enclosure of claim 45, wherein the enclosure unit has a shape selected from the group consisting of cube-shaped, spheroid-shaped and polyhedral-shaped.

53. The animal enclosure of claim 52, wherein the enclosure unit is cube-shaped and formed from one or more panels connected to one another by fastening means selected from the group consisting of adhesive bonding, joinery and stitching.

54. The animal enclosure of claim 53, wherein:
the enclosure unit is formed from one or more panels connected to one another by dovetail mortise and tenon joints;
the tenon is a through tenon with a substantially dovetail-shaped profile, said tenon extending from a peripheral edge of each panel and adapted to engage with and extend through a corresponding mortise disposed at or near the edge of an adjacent panel; and
the tenon, once it has engaged with and extended through a corresponding mortise, is secured by the fastening of a wedge or clip through an aperture in the protruding end of the tenon.

55. The animal enclosure of claim 45, wherein the enclosure unit is demountable or collapsible and optionally further includes locking means for locking a collapsed or demounted enclosure unit in a collapsed or demounted state.

56. The animal enclosure of claim 45, wherein:
the enclosure unit is formed from fabric supported by an internal frame;
the internal frame including a plurality of frame members; and
the fabric being attached to the internal frame by fastening means selected from the group consisting of hook and loop fasteners and snap fasteners.

57. The animal enclosure of claim 56, wherein the enclosure unit further includes locking means for locking the enclosure unit in a collapsed, expanded, or in at least a partially set up state.

58. The animal enclosure of claim 57, wherein the enclosure unit further includes one or more stabilizers for stabilizing the enclosure unit in the expanded state relative to the environment in which it has been set up.

59. The animal enclosure of claim 45, wherein the enclosure unit further includes an internal floor, said internal floor being substantially rigid and removable by an external access mechanism located on one or more walls of the enclosure unit.

60. The animal enclosure of claim 45, further including one or more removable dividing panels for dividing an internal space of the enclosure unit, said dividing panels optionally including one or more apertures to allow a confined animal access between a divided internal space of the enclosure unit.

61. The animal enclosure of claim 45, wherein the access mechanism includes an animal access flap to allow an animal access to enter and exit the enclosure unit, said animal access flap being configured to be movable between an open and closed position by an animal and to be locked or secured in the open or closed position.

62. The animal enclosure of claim 45, wherein the enclosure unit is spheroidally-shaped and includes a hemispherical base and a corresponding hatch or cover movable between an open and closed position.

63. The animal enclosure of claim 45, wherein the movement mechanism is selected from the group consisting of rollers, a sliding mat and wheels located on an external surface of the enclosure unit.

64. The animal enclosure of claim 45, wherein the attachment portions are located on the outside and/or the inside of the enclosure unit and each includes an aperture or a projection adapted to receive an attachment.
